(19) United States
(12) Patent Application Publication
(10) Pub. No.: US 2025/0383930 A1
(43) Pub. Date: Dec. 18, 2025

(54) Process Redistribution To Lower-Performance Nodes In A Cluster

(71) Applicant: NetApp, Inc., San Jose, CA (US)

(72) Inventors: Aravinda Chandrachari, Bangalore, Karnataka (IN); Aakanksha Saini, New Delhi, Delhi (IN); Shakeeb Kooriyattu Puthanpurayil, Perinthalmanna, Kerala (IN); Pankaj Kumar, Lauriya, Bihar (IN)

(21) Appl. No.: 18/927,337

(22) Filed: Oct. 25, 2024

(30) Foreign Application Priority Data
Jun. 18, 2024 (IN) 202441046740

(51) Int. Cl. G06F 9/50

(52) U.S. Cl. CPC G06F 9/5044; G06F 9/5072; G06F 9/5083

(57) ABSTRACT

The technology disclosed herein enables movement of a lower-performance pod to a lower-performance computing node from a higher-performance computing node. In a particular example, a method includes determining a lower-performance pod is executing on a higher-performance node without at least one higher-performance pod. The method also includes requesting instantiation of a dummy pod from a control plane of a cluster including the higher-performance node. The dummy pod identifies as lower performance to the control plane. In the control plane, the method includes adding a lower-performance node to the cluster, instantiating the dummy pod on the lower-performance node, and moving the lower-performance pod to the lower-performance node in response to determining a lower-performance node is available to host the lower-performance pod.

### RELATED APPLICATIONS

This application is related to and claims priority to Indian Provisional Patent Application No. 202441046740, titled “POD REDISTRIBUTION TO LOWER-PERFORMANCE NODES IN A CLUSTER,” filed June 18, 2024, and which is hereby incorporated by reference in its entirety.

### TECHNICAL FIELD

Scheduling of pods between computing nodes having different performance characteristics.

### BACKGROUND

Costs for cloud computing resources can add up quickly. Even small cost reduction measures can result in large savings over time, especially with large processing jobs. In one example that is pertinent to the innovation described below, computing nodes that are higher performance (e.g., nodes that have more processing cores or more powerful processors) will cost more than lower-performance nodes. As such, it is beneficial to run processing jobs on the lower-performance nodes when a higher-performance node is not necessary.

Kubernetes is a very popular open-source container orchestration platform designed to automate the deployment, scaling, and management of containerized applications. Specifically, Kubernetes groups containerized applications into pods that execute on computing nodes. While Kubernetes’ key features include automated load balancing, self-healing capabilities, and the ability to scale applications seamlessly based on demand, Kubernetes has no mechanism for moving pods from one node to another based on the performance capabilities of the nodes and the performance requirements of the pods. Kubernetes will not move a pod from an otherwise unused higher-performance node when the pod can execute on a lower-performance node. As such, a customer will have to pay for the higher-performance node even though a cheaper, lower-performance node would be better suited for the pod.

In one example, etcd is a distributed key-value store that is often used as a distributed data store in Kubernetes. In a typical Kubernetes cluster, etcd is deployed as a cluster itself, and the number of etcd pods depends on the desired level of fault tolerance and high availability. A common deployment scenario is to have an odd number of etcd pods (usually 3, 5, or 7) to ensure that the cluster can tolerate the loss of some nodes and still maintain quorum. Having an odd number helps to avoid split-brain scenarios where a majority of pods cannot agree on a decision (i.e., cannot achieve a quorum). The larger the number of pods, the greater the fault tolerance.

Etcd is not a very processing intensive application and, therefore, does not need to execute on a higher-performance node. However, when an application pod communicates with an etcd pod, it is more efficient that the two pods be executing on the same node (e.g., communications and data transfer can happen faster when remaining on node). If the node executing the application pod has spare capacity, then an etcd pod may be moved to the node. Should the application pod be removed from the node, the etcd pod will remain because, as noted above, Kubernetes has no mechanism to move the etcd pod from the higher-performance node.

### SUMMARY

The technology disclosed herein enables movement of a lower-performance pod to a lower-performance computing node from a higher-performance computing node. In a particular example, a method includes determining a lower-performance pod is executing on a higher-performance node without at least one higher-performance pod. The method also includes requesting instantiation of a dummy pod from a control plane of a cluster including the higher-performance node. The dummy pod identifies as lower performance to the control plane. In the control plane, the method includes adding a lower-performance node to the cluster, instantiating the dummy pod on the lower-performance node, and moving the lower-performance pod to the lower-performance node in response to determining a lower-performance node is available to host the lower-performance pod.

In other examples, an apparatus performs steps similar to those in the above-recited method and computer readable storage media directs a processing system to perform the similar steps.

In another example, a system includes a plurality of higher-performance servers in a cluster configured to execute higher-performance processes for the cluster and a control server configured to recognize a lower-performance process executing on a higher-performance server, determine the cluster lacks a lower-performance server to which the lower-performance process can be moved, and direct the cluster to execute a dummy process on the lower-performance server, wherein the cluster adds the lower-performance server to the cluster. The system includes the lower-performance server configured to execute the dummy process and execute the lower-performance process when the cluster recognizes the lower-performance server is available and moves the lower-performance process to the lower-performance server.

### BRIEF DESCRIPTION OF THE DRAWINGS

FIGS. 1A-1E illustrate an implementation for redistributing a lower-performance pod to a lower-performance node.

FIG. 2 illustrates an operation to redistribute a lower-performance pod to a lower-performance node.

FIG. 3 illustrates an implementation for redistributing a lower-performance pod to a lower-performance node.

FIG. 4 illustrates an operational scenario for redistributing a lower-performance pod to a lower-performance node.

FIG. 5 illustrates an operation to redistribute a lower-performance pod to a lower-performance node.

FIG. 6 illustrate an implementation for redistributing a lower-performance process to a lower-performance server.

FIG. 7 illustrates an operation to redistribute a lower-performance process to a lower-performance server.

FIG. 8 illustrates an operation to redistribute a lower-performance process to a lower-performance server.

FIG. 9 illustrates a computing system for redistributing a lower-performance pod to a lower-performance node.

### DETAILED DESCRIPTION

Given that lower-performance nodes (e.g., nodes that have fewer processing cores) are typically less costly to use in a computing cluster, it is beneficial to execute pods on a lower-performance node whenever possible. If, however, other pods are executing on higher-performance nodes (i.e., pods that require higher-performance nodes), then it may still be beneficial for a lower-performance pod to execute on one of those higher-performance nodes because the customer will be paying for the higher-performance node anyway. In addition to the cost benefits, pods that communicate with one another can communicate more efficiently if the communications remain on the same node rather than traversing a network.

Some workload management platforms for computing clusters, such as Kubernetes, employ a scheduler or similar component that distributes workloads, pods in the case of Kubernetes, across nodes of a cluster. At least in Kubernetes, the Scheduler is currently able to move pods between active nodes. Thus, if a higher-performance node hosting pods has available capacity, the scheduler may move a lower-performance pod from a lower-performance node to the higher performance node. If no pods remain on the lower-performance node after the move, the lower-performance node (and likely the costs associated therewith for the cluster owner) can be removed from the cluster.

To add and remove nodes from the cluster, workload management platforms like Kubernetes may also include an autoscaler or similar component. In Kubernetes, the autoscaler recognizes when new nodes are needed for the cluster to host pods and when nodes can be removed from the cluster. When the scheduler removes the lower-performance pod from the lower-performance node, the autoscaler may recognize the lower-performance node is no longer executing any pods and may remove the node from the cluster. Conversely, if a new pod cannot be hosted by the nodes currently in the cluster, the autoscaler may add a new node to the cluster to host the pod. For instance, a node of a performance level required by the new pod may not currently exist in the cluster or, if a node does exist, the existing node may not have capacity to handle the new pod. The autoscaler may then add a node that meets the new pod’s requirements to scale up the cluster.

If all pods in a cluster are all being hosted by nodes that at least satisfy the pods’ performance requirements, the scheduler and autoscaler do not have the ability to trigger adding a new lower-performance node to handle lower-performance pods. As such, a lower-performance pod will be left executing on a higher-performance node even though the higher-performance node and costs associated therewith are not needed.

To address the above-described inefficient use of resources, it may be possible to replace the scheduler and autoscaler components in a workload management platform. However, situations may exist where replacing the components are not possible or otherwise not desirable (e.g., replacement may require additional modifications to the management of the cluster). The parker component described herein allows for more efficient node usage while not otherwise affecting the operation of the scheduler/autoscaler-type components of the workload management platform. The parker leverages the current capabilities of a workload management platform’s control plane (e.g., scheduler and autoscaler) to move a lower-performance pod (or other workload unit) to a lower-performance node, which allows the control plane to scale down the higher-performance node from the cluster.

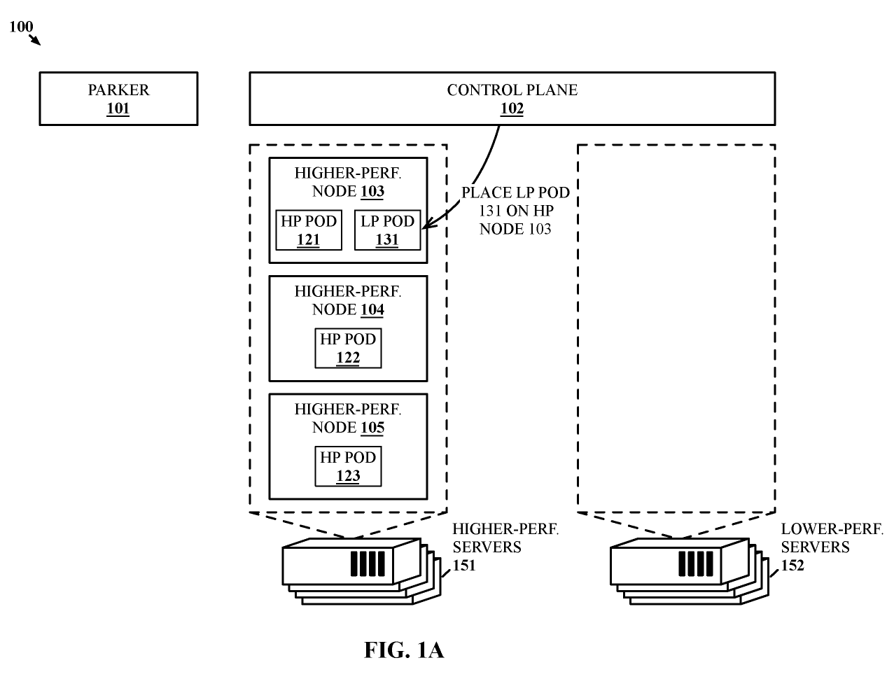

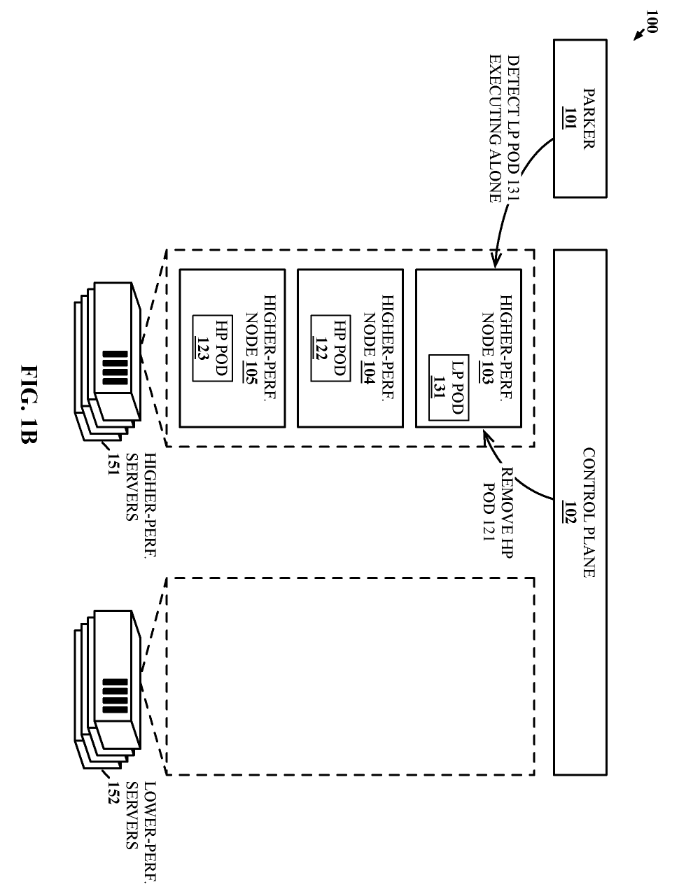

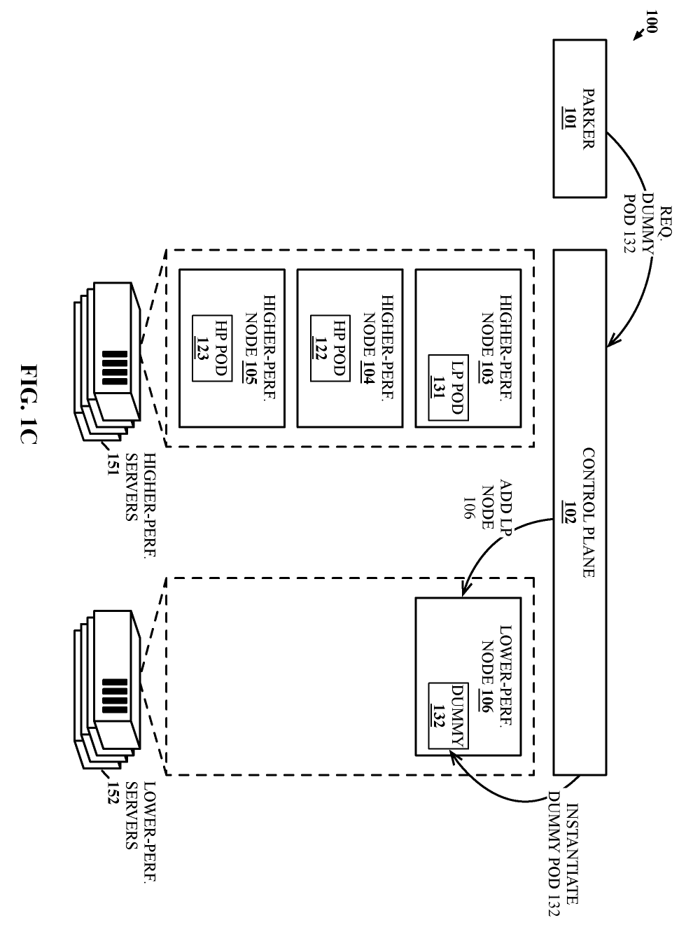

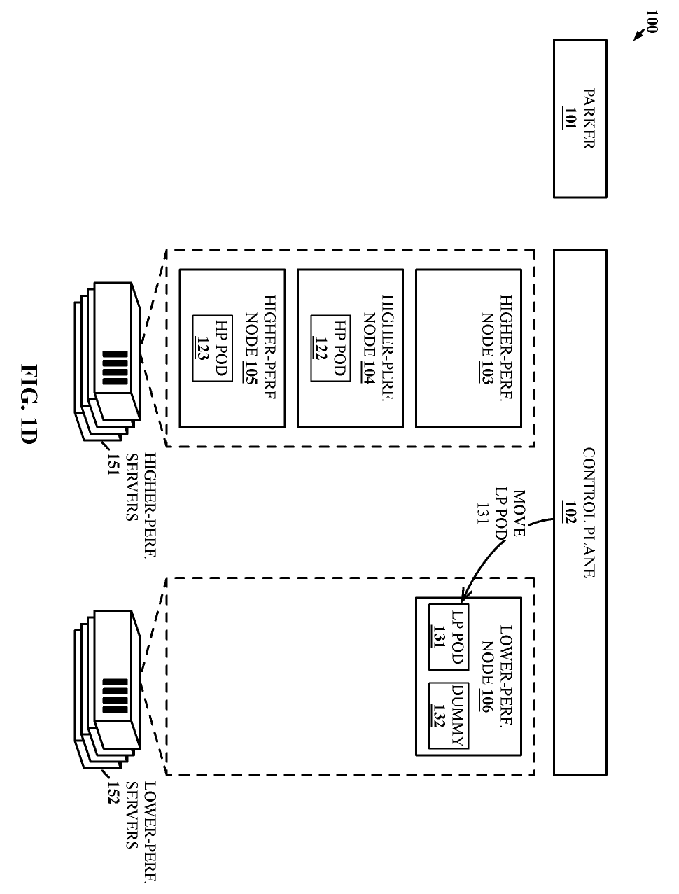

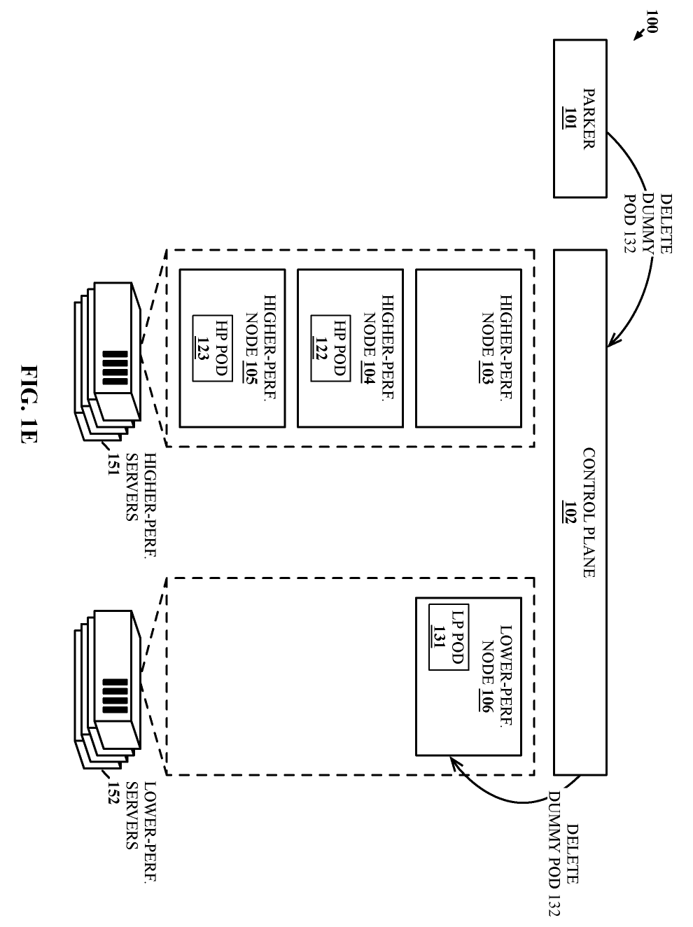

FIGS. 1A-1E illustrate implementation 100 for redistributing a lower-performance pod to a lower-performance node. As shown in FIG. 1A, implementation 100 includes parker 101, control plane 102, higher-performance servers 151, and lower-performance servers 152. Higher-performance servers 151 and lower-performance servers 152 may be provided by a cloud computing provider to host computing nodes of one or more clusters for one or more customers of the provider. Although, other arrangements for providing computing resources may also exist (e.g., an entity may provide higher-performance servers 151 and lower-performance servers 152 to internal customers of the entity). Higher-performance servers 151 are higher performance than lower-performance servers 152 in the sense that the hardware of higher-performance servers 151 is configured to handle greater processing loads, processing tasks that should be faster, more memory intensive processing tasks, or some other greater measure of computing performance – including combinations thereof. For example, higher-performance servers 151 may include more processing cores, faster processing cores, more Random Access Memory (RAM), faster RAM, faster graphics processing units (GPUs), specialized data processing circuitry, or some other hardware (or virtualized hardware) that renders higher-performance servers 151 higher performance than lower-performance servers 152. In an example, a higher-performance pod may require a higher-performance node having more GPU power than a lower-performance node (even if other components of the higher-performance node may be considered lower performance than those of the lower-performance node). While only two levels of performance are included in implementation 100, other examples may include more performance tiers (e.g., a tier between higher-performance servers 151 and lower-performance servers 152 or a tier above higher-performance servers 151). While nodes/servers and pods/processes are referred to herein as being lower-performance or higher-performance, it should be understood other differentiators between different types of nodes/servers and pods/processes configured to execute on those nodes/servers may also be used. For instance, a pod may be configured to execute on a node of one type preferably but can also execute on a node of another type much like the lower-performance pods are able to execute on higher-performance nodes despite being able to execute on lower-performance nodes. The different node types may not necessarily be considered to have differing performances (e.g., may have different physical locations while being the same type of hardware).

In operation, control plane 102 controls the operation of a workload management platform on higher-performance servers 151 and lower-performance servers 152. Control plane 102 handles formation of a cluster of computing nodes. A computing node is one of higher-performance servers 151 or lower-performance servers 152 in this example (e.g., each of higher-performance nodes 103-105 correspond to one of higher-performance servers 151). Although, virtualized computing nodes may be used in some examples. Control plane 102 may be configured to control only one cluster with other instances of control plane 102 configured to control other clusters on higher-performance servers 151 and lower-performance servers 152 or control plane 102 may be configured to control multiple clusters. Control plane 102 is shown as a separate element but may be executing on one of higher-performance servers 151 or lower-performance servers 152. In some examples, control plane 102 may include components distributed multiple servers across higher-performance servers 151 and lower-performance servers 152. For instance, components of control plane 102 may be executing on higher-performance nodes 103-105.

The nodes shown in implementation 100 are nodes of a particular cluster managed by control plane 102. Higher-performance servers 151 and lower-performance servers 152 may host other clusters in addition to the exemplified cluster. At least a portion of the nodes may be implemented as virtual machines on higher-performance servers 151 and lower-performance servers 152. In some examples, lower-performance nodes may be implemented as a lower-performance virtual machine (e.g., a virtual machine with a limited amount of computing resources relative to a higher-performance virtual machine) on one of higher-performance servers 151. The cluster currently includes higher-performance nodes 103-105, which are executing higher-performance pods 121-123, respectively. Other examples may use different types of workloads (e.g., containers, applications, virtual machines, etc.). Higher-performance pods 121-123 may be different instances of the same processing pod or may be different types of pods. Higher-performance pods 121-123 are higher-performance pods in the sense that they require the performance provided by higher-performance nodes 103-105 (i.e., servers of higher-performance servers 151) to execute. While there is only one higher-performance pod per higher-performance node in this example, higher-performance nodes 103-105 may host more than one higher-performance pod in other examples.

In this case, control plane 102 schedules lower-performance pod 131 on higher-performance node 103 along with higher-performance pod 121 rather than bringing a lower-performance node into the cluster to execute lower-performance pod 131. Lower-performance pod 131 may be added to higher-performance node 103 because control plane 102 determined higher-performance node 103 has spare capacity to handle a lower-performance pod in addition to higher-performance pod 121. In another example, lower-performance pod 131 may be complimentary to higher-performance pod 121 so control plane 102 determines it would be more efficient to execute lower-performance pod 131 on higher-performance node 103 even though the higher performance allotted by higher-performance node 103 is not necessary for lower-performance pod 131 to execute (i.e., lower-performance pod 131 is lower performance in that lower-performance pod 131 can run properly on lower-performance servers 152 and does not require the higher-performance resources provided by higher-performance servers 151). By executing the lower-performance pod 131 on higher-performance node 103 with other pods rather than a lower-performance node, the server of lower-performance servers 152 that would have been used for the lower-performance node can be used for other clusters (and any costs that may be associated with this clusters use of a lower-performance node are conserved).

In implementation 100 as shown in FIG. 1B, control plane 102 removes higher-performance pod 121 from higher-performance node 103. Lower-performance pod 131 is now the only remaining pod on higher-performance node 103. Control plane 102 is not configured to add a lower-performance pod when a lower-performance pod is running on a higher-performance node and no existing lower-performance node is available, as is the case in Kubernetes. Rather, control plane 102 is content with the fact that all pods are currently running on a node of some kind even though pods may not be distributed in a resource efficient and/or cost effective manner. Pods may not me distributed in a resource efficient manner when, for example, resources of one or more higher-performance nodes are being used to host only pods that do not need the higher-performance resources provided thereby. The underutilized higher-performance nodes could be used for other purposes. Likewise, the higher-performance nodes may be more expensive to include in the cluster and it may, therefore, be more cost effective to use lower-performance nodes instead. Therefore, parker 101 detects that lower-performance pod 131 is a lower-performance pod executing alone on a higher-performance node 103. Parker 101 may be an independent computing system or may be a process executing on one of higher-performance servers 151 or lower-performance servers 152 or may have components distributed across nodes of the cluster. For instance, a component of parker 101 may execute on higher-performance node 103 to monitor whether lower-performance pods are executing thereon without any higher-performance pods.

In implementation 100 as shown in FIG. 1C, parker 101 requests dummy pod 132 be instantiated in the cluster. Dummy pod 132 is a pod that is not intended to perform a processing function relevant to the workloads being handled by the cluster; hence the pod is referred to as being a dummy. Rather, dummy pod 132 is meant to trigger control plane 102 to include a lower-performance node on which dummy pod 132 can execute in the cluster. Thus, control plane 102 and the cluster will treat dummy pod 132 like any other pod that is performing processing tasks for the workloads even though any processing performed by the dummy pod will not contribute to, or otherwise affect, processing for the workloads. For example, dummy pod 132 may be configured to perform arbitrary arithmetic operations with results that are simply discarded or otherwise ignored. While control plane 102 is not configured to recognize that an existing lower-performance pod can be moved to a lower-performance node, control plane 102 will create a new lower-performance node for the cluster from one of lower-performance servers 152 when a new lower-performance pod requires. As such, the request from parker 101, or characteristics of dummy pod 132 itself, indicates requirements of dummy pod 132 such that control plane 102 is aware of the type of node is required to execute dummy pod 132. Specifically, dummy pod 132's requirements indicate that dummy pod 132 should execute on a lower-performance node.

After determining that dummy pod 132 should execute on a lower-performance pod, control plane 102 adds lower-performance node 106 to the cluster. Once lower-performance node 106 is added to the cluster, control plane 102 can fulfill parker 101's request by adding dummy pod 132 to lower-performance node 106. While dummy pod 132 is not intended to perform meaningful processing tasks, dummy pod 132 may still perform dummy tasks to ensure control plane 102 allows dummy pod 132 to remain on lower-performance node 106 long enough for lower-performance pod 131 to be moved to lower-performance node 106.

In FIG. 1D, implementation 100 is shown with control plane 102 having moved lower-performance pod 131 from higher-performance node 103 to lower-performance node 106. After control plane 102 added lower-performance node 106 to the cluster, a lower-performance node is available to execute lower-performance pods that may be executing on higher-performance nodes. In this case, control plane 102 recognizes that lower-performance pod 131 should be moved to lower-performance node 106 since higher-performance node 103 is otherwise not needed for the cluster (i.e., higher-performance node 103 is not executing any higher-performance pods). Control plane 102 ensures lower-performance node 106 has capacity to handle a pod in addition to dummy pod 132 but, since dummy pod 132 is intended to allow lower-performance pod 131 to join it on lower-performance node 106, dummy pod 132 is intentionally designed to ensure another lower-performance pod can execute on the same lower-performance node. As such, control plane 102 determines that lower-performance node 106 has capacity for lower-performance pod 131 to execute thereon with dummy pod 132 and moves lower-performance pod 131 to lower-performance node 106 accordingly.

In FIG. 1D, implementation 100 is shown with parker 101 determining that lower-performance pod 131 is now executing on lower-performance node 106. In response to that determination, parker 101 instructs control plane 102 to delete dummy pod 132, as dummy pod 132 has fulfilled its purpose and is no longer needed. Control plane 102 deletes dummy pod 132 in response to parker 101's instruction. With the removal of lower-performance pod 131 from higher-performance node 103, higher-performance node 103 is no longer executing any pods and can be removed from the cluster. Should control plane 102 remove higher-performance node 103 from the cluster, higher-performance node 103 can be used by other clusters. If a customer is paying for the computing resources of the cluster, then that customer may be charged less for not using a higher-performance node any longer.

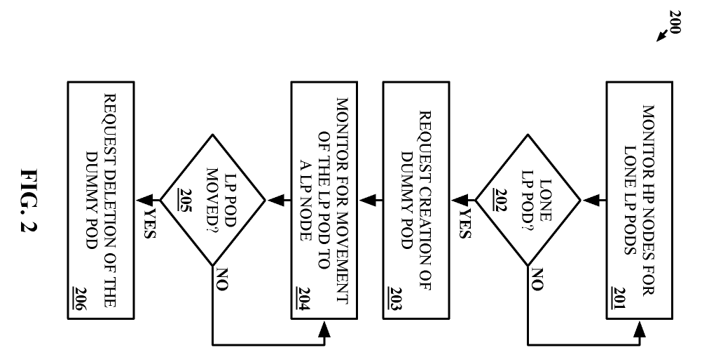

FIG. 2 illustrates operation 200 to redistribute a lower-performance pod to a lower-performance node. In operation 200, parker 101 monitors higher-performance nodes 103-105 for lone lower-performance pods (step 201). While the example of implementation 100 includes only a single lower-performance pod 131 executing alone on higher-performance node 103, other examples may include multiple lower-performance pods executing on a higher-performance node without any higher-performance pods (i.e., the lower-performance pods are alone due to the absence of higher-performance pods). If each of higher-performance nodes 103-105 are executing at least on higher-performance pod (step 202), then parker 101 continues to monitor at step 201. If, however, parker 101 identifies lower-performance pod 131 as being alone on higher-performance node 103, parker 101 requests creation of dummy pod 132 by control plane 102 (step 203).

After requesting creation of dummy pod 132, parker 101 monitors movement of lower-performance pod 131 to a lower-performance node (step 204). Since control plane 102 is configured to handle the movement, parker 101 simply waits for control plane 102 to perform as expected based on the configuration of control plane 102. Parker 101 takes advantage of control plane 102's configuration to trigger the movement of lower-performance pod 131. Specifically, parker 101 is configured with the knowledge of control plane 102's behavior when presented with instantiating a new lower-performance pod. As such, parker 101 uses that knowledge to request instantiation of dummy pod 132 to trigger creation of lower-performance node 106. Likewise, since control plane 102 is configured to move lone lower-performance pods to a lower-performance node, when a lower-performance node is in the cluster, parker 101 can be configured to wait until the identified lower-performance pod 131 is moved. Parker 101, therefore, continues to wait until it determines that lower-performance pod 131 has been moved (step 205).

Dummy pod 132 may be allowed to remain on lower-performance node 106 since dummy pod 132 is configured to not consume much in the way of resources on lower-performance node 106. However, dummy pod 132 may still affect how control plane 102 controls the cluster. For instance, if lower-performance pod 131 is removed from lower-performance node 106, control plane 102 may determine lower-performance node 106 should remain due to dummy pod 132 still executing thereon despite dummy pod 132 not performing any actual task. Thus, to ensure dummy pod 132 does not influence the determinations of control plane 102 after parker 101’s goal of having lower-performance pod 131 moved is accomplished, parker 101 requests that control plane 102 delete dummy pod 132 (step 206).

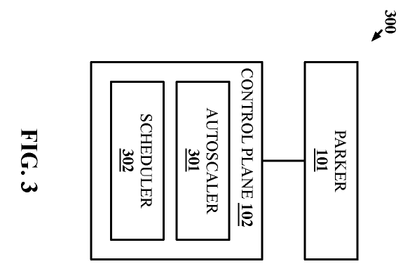

FIG. 3 illustrates implementation 300 for redistributing a lower-performance pod to a lower-performance node. Implementation 300 is an example where at least some of the functionality of control plane 102 described above is attributed to specific components of control plane 102. In this case, the specific components are autoscaler 301 and scheduler 302. For example, autoscaler 301 and scheduler 302 may represent the autoscaler and scheduler components of Kubernetes. Other types of workload management platforms may use different components to perform the functions described herein for autoscaler 301 and scheduler 302. At least in the context of Kubernetes, autoscaler 301 is configured to scale the number of nodes in a cluster depending on how many nodes are necessary to execute the pods currently required by the cluster. For instance, when processing needs increase, autoscaler 301 adds one or more nodes to the cluster to execute additional pods. Likewise, autoscaler 301 reduces the number of nodes in the cluster when fewer pods are needed. In this example, autoscaler 301 can select from both higher-performance nodes and lower-performance nodes when scaling the cluster depending on what type of node is needed by a pod.

Scheduler 302 is a component of control plane 102 responsible for placing pods onto nodes within the cluster to ensures efficient resource utilization and optimal performance. Scheduler 302 must select a higher-performance node for a higher-performance pod because higher-performance pods require higher-performance nodes. However, scheduler 302 may select either a higher-performance node or a lower-performance node (if a lower-performance node is available in the cluster) for a lower-performance pod because, while a lower-performance node will meet the requirements of a lower-performance pod, a higher-performance node will also meet those requirements. Thus, scheduler 302 may determine a lower-performance pod should execute on a higher-performance node. For instance, with respect to implementation 100, scheduler 302 may determine lower-performance pod 131 should execute on higher-performance node 103 with higher-performance pod 121. Scheduler 302 may have determined higher-performance node 103 has sufficient resource capacity to run a lower-performance pod in addition to higher-performance pod 121. Running a lower-performance pod on a higher-performance node with at least on higher-performance pod is more efficient from a resource usage perspective than adding an entire lower-performance node to the cluster just to run the lower-performance pod. The issue resolved by parker 101 is that scheduler 302 is not able to create a lower-performance node, as that is the job of autoscaler 301. Thus, even if scheduler 302 determines a lower-performance pod can be moved from a higher-performance node to a lower-performance node, the cluster may not have a lower-performance node to which the lower-performance pod can be moved (e.g., the cluster may not have a lower-performance node or the lower-performance nodes currently in the cluster do not have capacity, or are otherwise not available to handle the lower-performance pod). Likewise, since the lower-performance pod is executing on a node in the cluster (regardless of whether the node is unnecessarily higher performance), autoscaler 301 has no reason to add another node to the cluster.

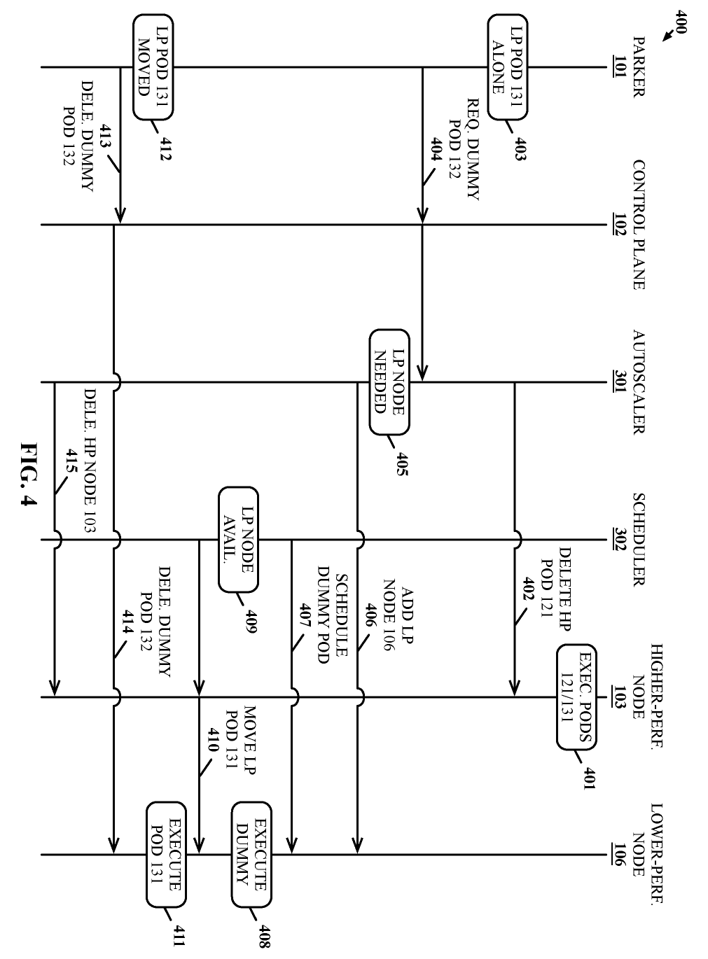

FIG. 4 illustrates operational scenario 400 to reestablish connections between worker nodes and a storage system. Operational scenario 400 begins with higher-performance pod 121 and lower-performance pod 131 both executing on higher-performance node 103 (step 401). At some point, autoscaler 301 deletes higher-performance pod 121 from higher-performance node 103 (step 402). Autoscaler 301 may delete higher-performance pod 121 because autoscaler 301 determined the cluster no longer needs the task processing being performed by higher-performance pod 121 (e.g., the current processing load may be handled adequately by higher-performance pod 122 and higher-performance pod 123). After autoscaler 301 deletes, or scales down, higher-performance pod 121, parker 101 recognizes that lower-performance pod 131 is running on higher-performance node 103 without any higher-performance pods (step 403). Parker 101 may communicate with control plane 102 or directly with higher-performance node 103 to determine which pods are executing on which nodes of the cluster.

In response to determining that lower-performance pod 131 is executing alone, parker 101 requests from control plane 102 that dummy pod 132 be instantiated (step 404). The request is processed by autoscaler 301 in control plane 102 to determine whether scaling of the cluster is necessary to accommodate dummy pod 132 (step 405). In this example, autoscaler 301 checks the requirements defined for dummy pod 132 and determines that dummy pod 132 is a lower-performance pod that should execute on a lower-performance node. In some cases, the requirements for dummy pod 132 may indicate that dummy pod 132 cannot execute on a higher-performance node to ensure dummy pod 132 will not be scheduled onto an existing higher-performance node. Since the cluster does not have a lower-performance node, autoscaler 301 scales the cluster by adding lower-performance node 106 to the cluster (step 406). With lower-performance node 106 now being available, scheduler 302 schedules dummy pod 132 on lower-performance node 106 to satisfy dummy pod 132's requirements (step 407). Dummy pod 132 executes on lower-performance node 106 to appear to control plane 102 like any other lower-performance pod that may be executing on lower-performance node 106 (step 408).

After lower-performance node 106 has been added to the cluster, scheduler 302 recognizes that the cluster is not operating as efficiently as the cluster could be. That is, scheduler 302 recognizes lower-performance pod 131 is executing without any higher-performance pods on higher-performance node 103 even though lower-performance node 106 is now available in the cluster (step 409). Accordingly, scheduler 302 communicates with higher-performance node 103 and lower-performance node 106 to move lower-performance pod 131 from higher-performance node 103 to lower-performance node 106 (step 410). Lower-performance pod 131 then executes on lower-performance node 106 along with dummy pod 132 (step 411).

Parker 101 recognizes when lower-performance pod 131 is executing on lower-performance node 106 (step 412). Like when parker 101 recognized lower-performance pod 131 was executing alone on higher-performance node 103, parker 101 may communicate with control plane 102 or directly with lower-performance node 106 for information needed to determine when lower-performance pod 131 is executing on lower-performance node 106. Once lower-performance pod 131 is executing on lower-performance node 106, dummy pod 132 is no longer needed to make lower-performance node 106 available to lower-performance pod 131. As such, parker 101 instructs control plane 102 to delete dummy pod 132 (step 413) and control plane 102 deletes dummy pod 132 from lower-performance node 106 in response to the instruction (step 414).

Additionally, with the movement of lower-performance pod 131 from higher-performance node 103, higher-performance node 103 is no longer executing any pods for the cluster. Autoscaler 301, therefore, recognizes that higher-performance node 103 is no longer needed in the cluster and scales down the cluster by removing higher-performance node 103 from the cluster (step 415). Higher-performance node 103 can then be used by other clusters utilizing higher-performance servers 151 and/or lower-performance servers 152 or, in situations where higher-performance node 103 is a virtual machine, the virtual machine can be deleted from the physical higher-performance server. Moreover, removal of higher-performance node 103 from the cluster also removes any further costs (monetary or otherwise) attributed to the cluster for including higher-performance node 103 and may enable cost savings for the computing provider if a physical server can be taken offline.

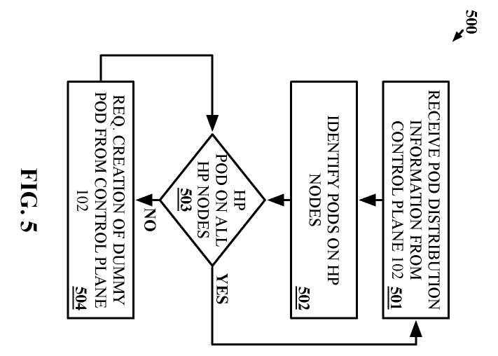

FIG. 5 illustrates operation 500 to redistribute a lower-performance pod to a lower-performance node. In operation 500, parker 101 receives information from control plane 102 about the distribution of pods across servers in the cluster (step 501). The information may be requested by parker 101 periodically, may be pushed to parker 101 periodically, may be pushed to parker 101 whenever a change occurs in the pod distribution, or may be retrieved by parker 101 using some other mechanism or on some other schedule. Parker 101 analyzes the received information to identify pods executing on higher-performance nodes (e.g., higher-performance nodes 103-105) (step 502). Parker 101 determines whether at least one higher-performance pod is executing on all higher-performance nodes in the cluster (step 503). If at least one higher-performance pod is executing on every higher-performance node, parker 101 need not do anything because the higher-performance capabilities of the higher-performance nodes are being used for higher-performance pods that require/utilize those capabilities. As such, parker 101 can repeat step 501 and wait until more pod distribution information is received.

If at least one higher-performance node is not executing a higher-performance pod, then parker 101 recognizes that one or more lower-performance pods are executing thereon. In response, parker 101 requests that control plane 102 create dummy pod in the cluster (step 504). The dummy pod is a lower-performance pod and neither control plane 102 nor the cluster itself need recognize that the dummy pod is not going to be performing any actual processing work for the cluster. Control plane 102 simply recognizes the dummy pod as being a pod that does not require the higher-performance of a higher-performance node. As such, control plane 102 adds a lower-performance node (e.g., lower-performance node 106) to the cluster to execute the dummy pod. The newly added lower-performance node is also available for other lower-performance pods to execute. Control plane 102 recognizes that the lower-performance node is available and moves lower-performance pod(s) on the higher-performance nodes without higher-performance pods to the lower-performance node.

In this example, there may be more lower-performance pods available to move from higher-performance nodes than can be handled by the new lower-performance node. As such, there may still be one or more lower-performance pods still running on higher-performance node(s) without at least one higher-performance pod. Parker 101 may, therefore, repeat creation of a dummy pod to trigger addition of another lower-performance node to the cluster, which can accept additional lower-performance pods.

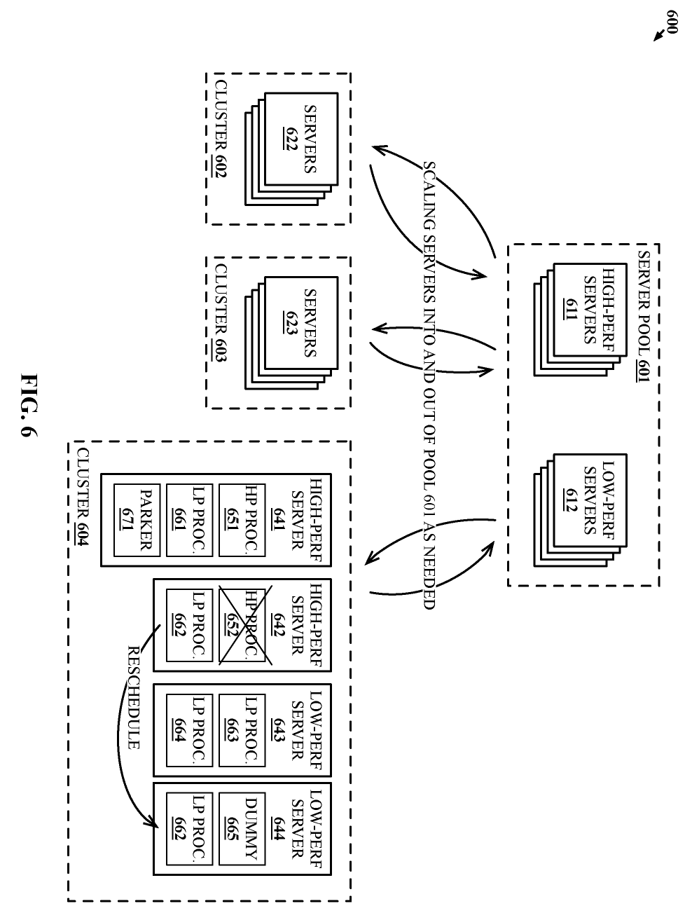

FIG. 6 illustrate implementation 600 for redistributing a lower-performance process to a lower-performance server. Implementation 600 includes higher-performance servers 611 and lower-performance servers 612 in server pool 601. Higher-performance servers 611 and lower-performance servers 612 are available from server pool 601 for inclusion in clusters 602-604. As such, servers 622 and servers 623 may include any combination of higher-performance servers and lower-performance servers (including entirely one or the other) taken from server pool 601. Cluster 604 includes higher-performance servers 641-642 from higher-performance servers 611 and lower-performance server 643 from lower-performance servers 612, with lower-performance server 644 being added to cluster 604 later as described below.

In operation, server pool 601 may be operated by a cloud computing provider. Customers of the cloud computing provider can use servers in server pool 601 to execute the customers’ desired processes. Clusters 602-604 may be different customers of the cloud computing provider or two or more of the clusters may belong to the same customer. The processes may include natively executing applications (e.g., processes that are not virtualized), virtualized application, such as those executing in containers (e.g., individually or organized into pods) or virtual machines, or some other form of software instructions and/or mechanism to execute the instructions on higher-performance servers 611 and lower-performance servers 612. In the examples above, the servers in a cluster are referred to as nodes and the processes are organized in pods but, as the example of implementation 600 shows, the mechanism for moving lower-performance processes to lower-performance servers need not be limited to node and pod environments. Similar, to higher-performance servers 151 and lower-performance servers 152, higher-performance servers 611 and lower-performance servers 612 are higher and lower performance in the sense that higher-performance servers 611 may have more/better computing resources thereon than lower-performance servers 612. For instance, a higher-performance server may include more memory, faster processing cores, more processing cores, or some other physical computing resource that enables the higher-performance server to have greater performance than a lower-performance server – including combinations thereof. Not all of higher-performance servers 611 need include the same specifications (e.g., one may be focused on having a large amount of memory while another may be focused on more processing cores for parallel processing).

Similar to control plane 102, the control logic operating clusters 602-604 does not add a lower-performance server to the cluster to move a lower-performance process from a higher-performance server when a higher-performance process is not also executing thereon. As such, the customer of the cloud computing provider may be paying more to include a higher-performance server in the customer’s cluster when the customer could spend less by using a lower-performance server instead to execute the lower-performance process. The control logic may include components similar to an autoscaler and scheduler described above. In this example, parker process 671 executes on higher-performance server 641 to overcome the above-described deficiency in cluster 604, as detailed below. Cluster 602 and cluster 603 may also include a parker process executing therein or parker process 671 may be configured to handle the operations described below for other clusters as well. While parker process 671 is described as executing on a server with other processes for cluster 604, parker process 671 may be executing on some other server in cluster 604 or a computing system outside of cluster 604, such as a system remote from server pool 601. Likewise, in some examples, parker process 671 may be distributed across multiple systems. A server executing parker process 671 may be considered a control server because parker process 671 is executing to control server usage in cluster 604 using dummy pods.

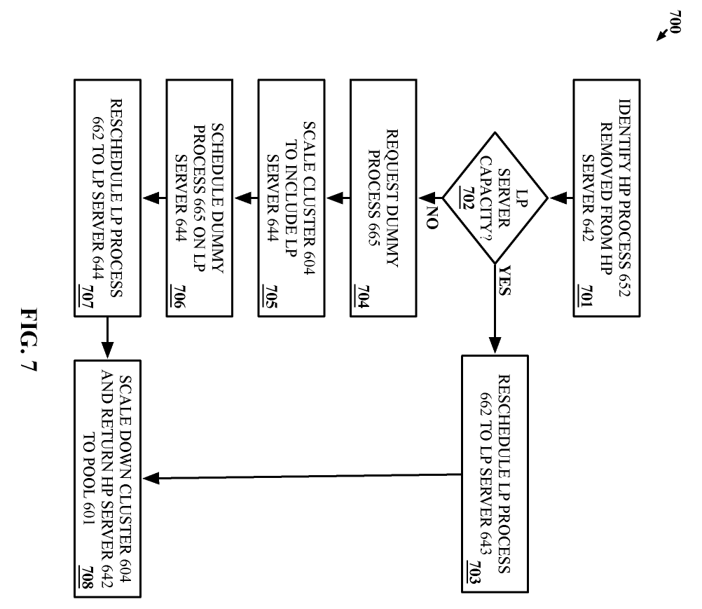

FIG. 7 illustrates operation 700 to redistribute a lower-performance process to a lower-performance server. Before performance of operation 700, cluster 604 includes higher-performance servers 641-642 and lower-performance server 643, which are taken from higher-performance servers 611 and lower-performance servers 612 of server pool 601. Higher-performance server 641 is executing higher-performance process 651 and lower-performance process 661 (and parker process 671), higher-performance server 642 is executing higher-performance process 652 and lower-performance process 662, and lower-performance server 643 is executing lower-performance processes 663-664.

In operation 700, parker process 671 identifies that higher-performance process 652 has been removed from higher-performance server 642 (step 701). Parker process 671 may interact with a control plane or other element of cluster 604 to recognize which processes are executing on which servers, parker process 671 may receive information from the processes themselves about where the processes are executing, or may receive the information from some other source. Higher-performance process 652 may be removed because higher-performance process 652 is no longer executing anywhere within cluster 604 (e.g., has been scaled down), higher-performance process 652 has crashed, higher-performance process 652 has been moved, or is no longer executing on higher-performance server 642 for some other reason. Removal of higher-performance process 652 means no higher-performance processes are executing on higher-performance server 642 but higher-performance server 642 cannot be scaled from cluster 604 because lower-performance process 662 is still executing thereon.

The control logic of cluster 604 determines whether a lower-performance server in cluster 604 has capacity (e.g., has enough available memory, processing resources, etc.) to execute lower-performance process 662 (step 702). In this case, cluster 604 already includes lower-performance server 643. If lower-performance server 643 does have capacity, the control logic reschedules higher-performance process 652 to lower-performance server 643 along with lower-performance process 663 and lower-performance process 664 (step 703). If lower-performance server 643 does not have capacity, the control logic of cluster 604 does not include to add a lower-performance server to cluster 604 to accommodate lower-performance process 662. As such, but for parker process 671, which is not part of the underlying control logic for cluster 604, lower-performance processes may continue to execute on potentially costlier higher-performance servers.

To trigger the control logic of cluster 604 to move lower-performance process 662 to a lower-performance server, parker process 671 requests dummy process 665 be executed in cluster 604 (step 704). Dummy process 665 is identified to cluster 604 as being a lower-performance process. Depending on the control logic of cluster 604 to trigger addition of a new lower-performance server, dummy process 665 may indicate that a lower-performance server meets the resource requirements of dummy process 665 or may indicate that a lower-performance server is required for dummy process 665 to execute. In the latter situation, the lower-performance server requirement indication may be necessary because otherwise dummy process 665 may be scheduled to execute on higher-performance server 642 with lower-performance process 662 when the goal was to get lower-performance process 662 off of higher-performance server 642. In some examples, the resource requirements of dummy process 665 may be indicated to cluster 604 as being greater than that available on lower-performance server 643 so that dummy process 665 is not simply scheduled to execute on lower-performance server 643.

In response to receiving the instruction to execute dummy process 665, cluster 604 scales to include lower-performance server 644 from lower-performance servers 612 in cluster 604 (step 705). The control logic then schedules dummy process 665 to execute on lower-performance server 644 (step 706). While lower-performance server 643 did not have capacity to execute lower-performance process 662, lower-performance server 644 does have capacity because the resource requirements of dummy process 665 are set low enough to ensure capacity is available for lower-performance process 662. Since dummy process 665 is not doing any relevant processing to the workloads of cluster 604, the resource requirements of dummy process 665 indicated to cluster 604 can be whatever parker process 671 determines are necessary to achieve the desired result of adding a lower-performance server to cluster 604 and moving lower-performance process 662 thereto.

Once lower-performance server 644 is added to cluster 604, the control logic of cluster 604 recognizes that a lower-performance server exists in cluster 604 with capacity to execute lower-performance process 662 and reschedules lower-performance process 662 to execute on lower-performance server 644 (step 707). Removing lower-performance process 662 from higher-performance server 642 means higher-performance server 642 is no longer needed for the workload(s) being handled by cluster 604. The control logic of cluster 604 scales down cluster 604 by removing higher-performance server 642 and returning higher-performance server 642 to higher-performance servers 611 of server pool 601 (step 708). With higher-performance server 642 back in server pool 601, higher-performance server 642 can be used by other clusters or may be scaled back into cluster 604 should additional higher-performance server capacity be needed at a later time. Higher-performance server 642 is similarly scaled down in the example where lower-performance process 662 was moved to lower-performance server 643 in step 703. Parker process 671 may also recognize when lower-performance process 662 is moved to lower-performance server 644 and direct cluster 604 to end execution of dummy process 665 since the purpose of dummy process 665 has been served.

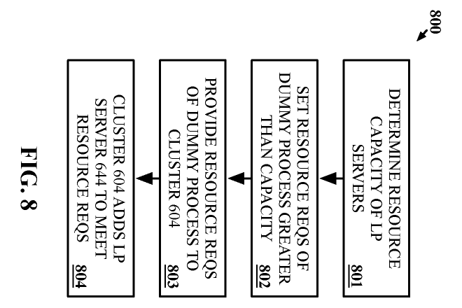

FIG. 8 illustrates operation 800 to redistribute a lower-performance process to a lower-performance server. Operation 800 is an example for how parker process 671 may determine the resource requirements of dummy process 665 to achieve the desired result of adding lower-performance server 644 to cluster 604. Specifically, parker process 671 determines the resource capacity of lower-performance servers in cluster 604 (step 801). While cluster 604 only includes a single lower-performance server (i.e., lower-performance server 643) prior to execution of dummy process 665, other examples may include multiple lower-performance servers in the cluster. Parker process 671 may query the lower-performance servers directly for information regarding their capacity to handle additional processes, may query or otherwise receive information about capacity from control logic of cluster 604, or may obtain the capacity information from some other source.

In this example, the control logic of cluster 604 will simply add dummy process 665 to an existing lower-performance server if dummy process 665 indicates resource requirements that can be handled by the existing lower-performance server. Thus, to trigger addition of a new lower-performance server, parker process 671 sets the resource requirement of 665 to be greater than what capacity available at any existing server (step 802). For example, if lower-performance server 643 has 3GB of Random Access Memory (RAM) available, parker process 671 may indicate dummy process 665 requires more than 3GB of RAM. Parker process 671 provides the resource requirements to cluster 604 (step 803). The resource requirements may be incorporated into an executable for dummy process 665 or may be provided to cluster 604 via some other channel. Upon receiving the resource requirements, the control logic of cluster 604 recognizes lower-performance server 643 does not have capacity to execute dummy process 665. The control logic, therefore, scales cluster 604 to include lower-performance server 644, which does have capacity to execute dummy process 665 (step 804).

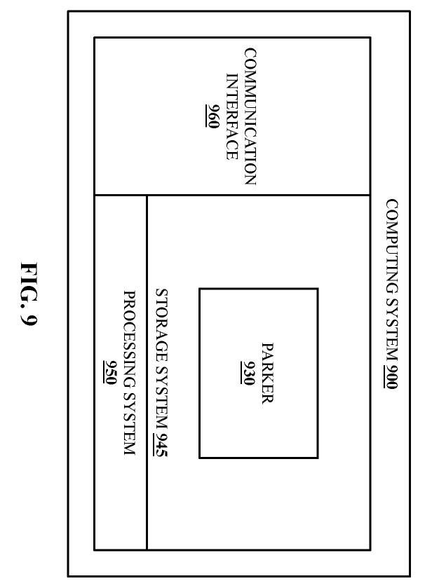

FIG. 9 illustrates a computing system 900 for redistributing a lower-performance pod to a lower-performance node. Computing system 900 is representative of any computing system or systems with which the various operational architectures, processes, scenarios, and sequences disclosed herein can be implemented. Computing system 900 is an example architecture for higher-performance servers 151, lower-performance servers 152, higher-performance servers 611, and lower-performance servers 612, although other examples may exist. Computing system 900 includes storage system 945, processing system 950, and communication interface 960. Processing system 950 is operatively linked to communication interface 960 and storage system 945. Communication interface 960 may be communicatively linked to storage system 945 in some implementations. Computing system 900 may further include other components such as a battery and enclosure that are not shown for clarity.

Communication interface 960 comprises components that communicate over communication links, such as network cards, ports, radio frequency (RF), processing circuitry and software, or some other communication devices. Communication interface 960 may be configured to communicate over metallic, wireless, or optical links. Communication interface 960 may be configured to use Time Division Multiplex (TDM), Internet Protocol (IP), Ethernet, optical networking, wireless protocols, communication signaling, or some other communication format – including combinations thereof. Communication interface 960 may be configured to communicate with other computing systems via one or more networks.

Processing system 950 comprises microprocessor and other circuitry that retrieves and executes operating software from storage system 945. Storage system 945 may include volatile and nonvolatile, removable, and non-removable media implemented in any method or technology for storage of information, such as computer readable instructions, data structures, program modules, or other data. Storage system 945 may be implemented as a single storage device but may also be implemented across multiple storage devices or sub-systems. Storage system 945 may comprise additional elements, such as a controller to read operating software from the storage systems. Examples of storage media include random access memory, read only memory, magnetic disks, optical disks, and flash memory, as well as any combination or variation thereof, or any other type of storage media. In some implementations, the storage media may be a non-transitory storage media. In some instances, at least a portion of the storage media may be transitory. In no interpretations would storage media of storage system 945, or any other computer-readable storage medium herein, be considered a transitory form of signal transmission (often referred to as "signals per se"), such as a propagating electrical or electromagnetic signal or carrier wave.

Processing system 950 is typically mounted on a circuit board that may also hold the storage system. The operating software of storage system 945 comprises computer programs, firmware, or some other form of machine-readable program instructions. The operating software of storage system 945 comprises parker module 930. The operating software on storage system 945 may further include an operating system, utilities, drivers, network interfaces, applications, or some other type of software. When read and executed by processing system 950 the operating software on storage system 945 directs computing system 900 to network routing advertisements as described herein. Parker module 930 may execute natively on processing system 950 or the operating software may include virtualization software, such as a hypervisor, to virtualize computing hardware on which parker module 930 executes.

In at least one example, parker module 930 executes on processing system 950 and directs processing system 950 to determine a lower-performance pod is executing on a higher-performance node without at least one higher-performance pod. Parker module 930 executes on processing system 950 and directs processing system 950 to request instantiation of a dummy pod from a control plane of a cluster including the higher-performance node. The dummy pod identifies as lower performance to the control plane. The control plane adds a lower-performance node to the cluster, instantiates the dummy pod on the lower-performance node, and moves the lower-performance pod to the lower-performance node in response to determining a lower-performance node is available to host the lower-performance pod.

The included descriptions and figures depict specific implementations to teach those skilled in the art how to make and use the best mode. For teaching inventive principles, some conventional aspects have been simplified or omitted. Those skilled in the art will appreciate variations from these implementations that fall within the scope of the invention. Those skilled in the art will also appreciate that the features described above can be combined in various ways to form multiple implementations. As a result, the invention is not limited to the specific implementations described above, but only by the claims and their equivalents.

What is claimed is:

1. A method for redistributing lower-performance pods to lower-performance nodes, the method comprising:
determining a lower-performance pod is executing on a higher-performance node without at least one higher-performance pod;
requesting instantiation of a dummy pod from a control plane of a cluster including the higher-performance node, wherein the dummy pod identifies as being lower performance to the control plane; and
in the control plane:
adding a lower-performance node to the cluster in accordance with the dummy pod identifying as being lower performance;
instantiating the dummy pod on the lower-performance node; and
in response to determining a lower-performance node is available to host the lower-performance pod, moving the lower-performance pod to the lower-performance node.

2. The method of claim 1, comprising:
in the control plane:
determining the higher-performance node is not executing any pods after the lower-performance pod is moved to the lower-performance node; and
in response to determining the higher-performance node is not executing any pods, removing the higher-performance node from the cluster.

3. The method of claim 1, comprising:
instructing the control plane to delete the dummy pod from the lower-performance node after moving the lower-performance pod to the lower-performance node.

4. The method of claim 1, wherein adding the lower-performance node comprises:
in an autoscaler of the control plane:
determining performance requirements of the dummy pod;
in response to the performance requirements being satisfied by a lower-performance node, determining the lower-performance node should be added to execute the dummy pod in the cluster; and
in response to determining the lower-performance node should be added, scaling the cluster to include the lower-performance node.

5. The method of claim 4,. determining the lower-performance node should be added comprises either:
determining no lower-performance node currently in the cluster has capacity to support the dummy pod; or
determining the cluster currently lacks lower-performance nodes.

6. The method of claim 1, wherein instantiating the dummy pod on the lower-performance node comprises:
in a scheduler of the control plane:
identifying the lower-performance node as preferable for handling execution of the dummy pod; and
scheduling the dummy pod at the lower-performance node.

7. The method of claim 1, wherein moving the lower-performance pod to the lower-performance node comprises:
in a scheduler of the control plane:
recognizing the lower-performance node is a better fit to execute the lower-performance pod than the higher-performance node; and
rescheduling the lower-performance pod from the higher-performance node to the lower-performance node.

8. The method of claim 1, comprising:
in an autoscaler of the control plane:
determining the higher-performance node is unused after the lower-performance pod is moved to the lower-performance node; and
in response to determining the higher-performance node is unused, scaling down the higher-performance node from the cluster.

9. A system for redistributing lower-performance processes to lower-performance servers, the system comprising:
a plurality of higher-performance servers in a cluster configured to execute higher-performance processes for the cluster;
a control server configured to:
recognize a lower-performance process executing on a higher-performance server;
determine the cluster lacks a lower-performance server to which the lower-performance process can be moved; and
direct the cluster to execute a dummy process on the lower-performance server, wherein the cluster adds the lower-performance server to the cluster; and
the lower-performance server configured to:
execute the dummy process; and
execute the lower-performance process when the cluster recognizes the lower-performance server is available and moves the lower-performance process to the lower-performance server.

10. The system of claim 9, comprising the control server configured to:
determine the lower-performance process moved to the lower-performance server; and
direct the cluster to end execution of the dummy process in response to the lower-performance process being moved.

11. The system of claim 9, wherein, after the lower-performance process is moved to the lower-performance server, the cluster automatically removes the higher-performance server from the cluster unless the higher-performance server is executing another process.

12. The system of claim 9, wherein to direct the cluster to execute the dummy process, the control server is configured to:
determine resource requirements that enable the dummy process to execute on the lower-performance server; and
provide the resource requirements to the cluster with the dummy process, wherein the cluster determines the lower-performance server should execute the dummy process because the lower-performance server satisfies the resource requirements.

13. The system of claim 12, wherein:
the resource requirements indicate the dummy process is required to execute on the lower-performance server; and
the resource requirements allow for enough resources of the lower-performance server to remain available for execution of the lower-performance process.

14. The system of claim 9, wherein to determine the cluster lacks a lower-performance server, the control server is configured to:
determine resource requirements of the lower-performance process; and
determine the resource requirements cannot be satisfied by a plurality of lower-performance servers in the cluster.

15. The system of claim 9, wherein the plurality of higher-performance servers and the lower-performance server are taken from a pool of servers available to a plurality of clusters and wherein, after the lower-performance process is moved from the higher-performance server, the higher-performance server is returned to the pool of servers.

16. The system of claim 9, wherein the control server comprises at least one server of the cluster.

17. A method for redistributing lower-performance pods to lower-performance nodes, the method comprising:
upon determining a new lower-performance node should be included in a cluster to execute a lower-performance dummy pod;
scaling the cluster to include the new lower-performance node;
upon identifying the new lower-performance node in the cluster, scheduling the lower-performance dummy pod to the new lower-performance node;
determining the new lower-performance node is available to execute a lower-performance pod executing on a higher-performance node of the cluster; and
rescheduling the lower-performance pod to the new lower-performance node with the lower-performance dummy pod.

18. The method of claim 17, comprising:
determining the higher-performance node is no longer being used by the cluster after the lower-performance pod is rescheduled; and
scaling the cluster to remove the higher-performance node.

19. The method of claim 17, comprising:
receiving an instruction from a parker requesting execution of the lower-performance dummy pod; and
determining the lower-performance dummy pod requires the new lower-performance node to execute.

20. The method of claim 17,. determining the lower-performance dummy pod requires the new lower-performance node to execute comprises:
identifying resource requirements of the lower-performance dummy pod;
determining whether an existing lower-performance node in the cluster has capacity to meet the resource requirements; and
determining the new lower-performance node should be added to the cluster when the resource requirements cannot be met.
